(19) United States
(12) Patent Application Publication
(10) Pub. No.: US 2015/0152994 A1
(43) Pub. Date: Jun. 4, 2015

(54) OUTER COATING FOR AN IRON-BASED BURIED PIPING ELEMENT, COATED PIPING ELEMENT AND METHOD FOR DEPOSITING THE COATING

(71) Applicant: SAINT-GOBAIN PAM, Nancy (FR)

(72) Inventors: Olivier Bondil, Pont-A-Mousson (FR); Gerard Nouail, Metz (FR); Jean-Marc Pedeutour, Blenod-Les-Pont-A-Mousson (FR)

(21) Appl. No.: 14/411,034

(22) PCT Filed: Jun. 28, 2013
(86) PCT No.: PCT/EP2013/063717

§ 371 Date: Dec. 23, 2014

(30) Foreign Application Priority Data
Jun. 29, 2012 (FR) 12562268

(51) Int. Cl. F16L 58/02; C23C 4/08; C23C 4/12; B05D 7/14

(52) U.S. Cl. CPC F16L 58/02; B05D 7/146; C23C 4/08; C23C 4/125

(57) ABSTRACT

The invention relates to an outer coating (9) for an underground piping element (7) made from iron, in particular cast iron, the outer coating having a first porous layer (11) and a second porous layer (13) positioned on the first layer and able to plug the pores of the first layer, the outer coating being characterized in that:
the first layer includes a substantially pure zinc or a zine alloy or pseudo-alloy, the alloy or pseudo-alloy including, in terms of mass, at least 50% zinc, preferably between 0.5% and 40% aluminum, and
the second layer comprises a one-component paint in the aqueous phase made from at least one synthetic resin emulsified, dispersed or dissolved in water.

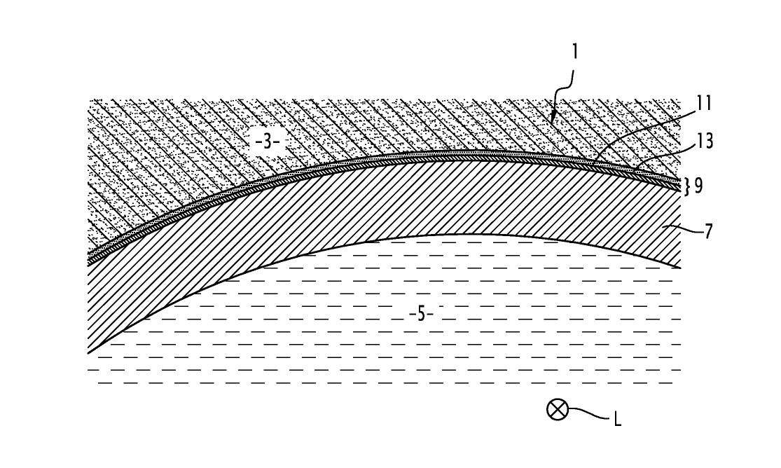

The invention also relates to a corresponding coated piping element and method for depositing the coating.

The present invention relates to an outer coating of the type for an underground piping element made from iron, in particular cast iron, the outer coating having a first porous layer and a second porous layer positioned on the first layer and able to plug the pores of the first layer.

The invention also relates to a piping element coated with this outer coating, as well as a method for depositing a coating on the piping element.

“Piping elements” refers to pipes, as well as the various accessories such as elbows, connectors, etc., for example used in the waterworks field.

A method for manufacturing a coating for a steel tube is known from document JP-A-23010357. This document considers deposition by spraying a sacrificial zinc/aluminum alloy, followed by depositing an epoxy resin. It appears that the resin layer must be tight. This method applies to coatings for tubes in a “drying area”, and therefore certainly overhead tubes, made from iron or steel.

The phenomenon of corrosion of the ferrous metals due to soil is different from atmospheric corrosion and essentially consists of the creation of oxidation zones electrically associated with reduction zones that may be situated at a certain distance. Consequently, localized, and therefore significant, deteriorations of the ferrous metal occur.

Corrosion protection for underground piping elements is thus particularly difficult, especially given that the terrains are heterogeneous and of quite varied natures; the piping elements convey fluids at different temperatures, depending on their use, altering the corrosion conditions; and the handling of the piping elements intended to be placed underground frequently leads to damage to various locations of their outer surfaces.

Document EP-A-0,686,246 describes a piping element made from ductile cast iron and comprising a coating including a first porous metallized layer and a second layer of paint providing a “pore plugging” effect. This coating provides effective and lasting protection for the piping against corrosion, once the piping is placed underground. However, the sanitary and environmental aspects of this coating no longer meet the requirements currently in force.

One aim of the invention is to supply a coating providing even more effective corrosion protection for the piping element, in particular in corrosive soil, with a competitive price and improved sanitary and environmental properties.

To that end, the invention relates to an outer coating of the type described above, wherein:
the first layer includes a substantially pure zinc or a zinc alloy or pseudo-alloy, the alloy or pseudo-alloy including, in terms of mass, at least 50% zinc, and preferably between 0.5% and 40% aluminum, and
the second layer comprises a one-component paint in the aqueous phase made from at least one synthetic resin emulsified, dispersed or dissolved in water.

According to specific embodiments, the outer coating may include one or more of the following features, considered alone or according to any technically possible combination(s):
said at least one synthetic resin is formulated from at least one polymer or at least one copolymer chosen from the list consisting of acrylic, styrene acrylic, vinyl halide such as vinyl chloride, polyvinyl chloride acrylate, vinylidene halide such as vinylidene chloride, vinyl, methacrylate, polyvinyl acetate polymers or copolymers, and mixtures thereof;
the first layer includes magnesium and/or copper and/or silver, at respective mass concentrations of between 0% and 5%, preferably between 0.5% and 3%;
the first layer has a surface density of at least 200 g/m², preferably at least 350 g/m²;
the second layer has no organic solvent or co-solvent, in particular solvent or co-solvent derived from hydrocarbons, and without bisphenol;
the second layer includes one or more active ingredients able to come into contact with water intended for human consumption and have a bactericidal and/or passivating action;
the second layer has a dry surface density comprised between 120 g/m² and 350 g/m²;
the first layer is deposited by thermal spraying, preferably by electric arc;
the piping contains, by mass, between 20% and 60%, preferably between 30% and 50%, water; between 20% and 70%, preferably between 25% and 45%, of at least one synthetic resin; and between 1% and 30% of at least one organic or mineral pigment/dye;
said at least one organic or mineral pigment/dye is chosen from the list consisting of a metal oxide such as iron oxide, titanium oxide, chromium oxide, carbon black, copper phthalocyanine, and mixtures thereof;
the paint contains, by mass, between 1% and 10% of at least one anticorrosion pigment;
said at least one anticorrosion pigment is chosen from the list consisting of zinc phosphate, zinc oxide, modified zinc oxide, and mixtures thereof;
the paint contains, by mass, between 10% and 40% of at least one filler chosen from the list consisting of barite sulfate, calcium carbonate, talc, mica, silicates, silica, kaolin, dolomite, and mixtures thereof; and
the paint contains, by mass, between 0.1% and 5% of at least one paint additive chosen from the list consisting of thickening, passivating, biocidal, bactericidal, wetting, dispersive, anticorrosion, antifoaming, emulsifying, surfactant agents, and mixtures thereof.

The invention also relates to a coated piping element, made from iron, in particular cast iron, designed to be placed underground, including an outer coating as described above.

The invention lastly relates to a method for depositing an outer coating on a piping element made from iron, in particular cast iron, designed to be placed underground, the method including the following steps:

a) deposition by metallization, preferably by electric arc, on the piping element of a first porous layer including substantially pure zinc or a zinc alloy or pseudo-alloy, the alloy or pseudo-alloy including, in terms of mass, at least 50% zinc, and preferably between 0.5% and 40% aluminum, and

b) deposition on the first layer, not covered with white efflorescence, of a second porous layer including a one-component paint in aqueous phase, made from at least one synthetic resin emulsified, dispersed or dissolved in the water.

According to specific embodiments, the method may include one or more of the following features, considered alone or according to any technically possible combination(s):
in step b), said at least one synthetic resin is formulated from at least one polymer or at least one copolymer chosen from the list consisting of acrylic, styrene acrylic, vinyl halide such as vinyl chloride, polyvinyl chloride acrylate, vinylidene halide such as vinylidene chloride, vinyl, methacrylate, polyvinyl acetate polymers or copolymers, and mixtures thereof;
step b) for depositing the second layer is done by gun, and/or with a brush or roller, such that the second layer has a dry thickness comprised between 60 μm and 150 μm;
step b) for depositing the second layer is done such that the second layer has a dry surface density comprised between 120 g/m² and 350 g/m²;
step b) for depositing the second layer is at least partially done by gun with no compressed air, the application by gun being done on a surface having a temperature comprised between 35° C. and 60° C.;
in step b), said surface is brought to the temperature comprised between 35° C. and 60° C. by immersing at least part of the piping element in water preferably containing a surface conversion agent to cover the first layer with a superficially transformed alloy film, the conversion agent being suitable for contact with water intended for human consumption;
said at least one synthetic resin is formulated from at least one polymer or copolymer chosen from the list of acrylic, styrene acrylic, vinyl halide such as vinyl chloride, polyvinyl chloride acrylate, vinylidene halide such as vinylidene chloride, vinyl, methacrylate, polyvinyl acetate polymers or copolymers, and mixtures thereof;
in step a), the first layer is deposited by thermal spraying, preferably by electric arc;
in step b), the second layer has no organic solvent, in particular solvent derived from hydrocarbons, and without bisphenol; and
in step b), the second layer includes one or more active ingredients able to come into contact with water intended for human consumption and have a bactericidal and/or passivating action;
step b) for depositing the second layer is done by gun with compressed air;
step b) for depositing the second layer is done by gun without compressed air.

The invention will be better understood upon reading the following description, provided solely as an example, and done in reference to the sole figure, which is a diagrammatic partial view of a cross-section of a piping element according to the invention.

The figure shows a coated piping element 1 placed underground in soil 3 and used to transport a fluid 5, for example drinking water.

The coated piping element 1 includes a piping element 7 and an outer coating 9 situated between the soil 3 and the piping element 7, advantageously distributed over the piping element 7 so as to insulate it from the ground 3.

The piping element 7 is made from iron, advantageously ductile cast iron. The piping element 7 is for example a pipe. In the illustrated example, it extends in a longitudinal direction L perpendicular to the plane of the figure. Only a portion of the section of the piping element 7 is shown in figure, the rest of the section being able to be extrapolated without difficulty from the illustrated portion.

The fluid 5 flows inside the piping element 7 in the longitudinal direction L. An inner coating, not shown, may exist on an inner wall of the piping element 7, to insulate the fluid 5 from the piping element 7.

The outer coating 9 includes a first layer 11 and a second layer 13 positioned on the first layer 11.

The first layer 11 is porous and advantageously deposited by electric arc metallization. The first layer 11 includes substantially pure zinc, for example having a mass concentration greater than or equal to 99.9%, or a zinc alloy or pseudo-alloy. The alloy or pseudo-alloy includes, in terms of mass, at least 50% zinc, and between 0.5% and 40% aluminum. For example, the first layer 11 includes 85% zinc and 15% aluminum in terms of mass.

Under the action of the corrosive agents from the soil, the first layer 11 transforms into a layer protecting products from corrosion that is stable in the medium where it originated. The zinc/aluminum alloy layer is also said to be “anodic” with respect to the cast iron, inasmuch as it can gradually transform by oxidation under the effect of the electrochemical cell formed by the cast iron, the alloy and the soil, to protect the underlying or stripped cast iron at defects in the alloy layer, by forming said protective layer.

Because it is deposited by arc metallization, the first layer 11 is made up of solidified, and therefore porous, droplets. By adapting the adjustments of the metallization method governing the size of the pores and the thickness of the layer, one skilled in the art can adjust the conditions, in particular the speed, for formation of the protective layer. It has been observed that the biphasic structure of the zinc/aluminum alloy favors the trapping of fabricated products of the zinc.

Advantageously, the first layer 11 also includes magnesium and/or copper and/or silver, with a mass content level comprised between 0 and 5%. These elements are for example added in elementary, or oxide, form.

The first layer 11 has a surface density of at least 200 g/m², preferably at least 350 g/m², for example approximately 400 g/m². Advantageously, the first layer 11 is deposited by thermal spraying, to obtain the aforementioned densities.

The second layer 13 is a paint in aqueous phase (before drying), also called “water-based”. The second layer 13 is porous and makes it possible to ensure proper operation of the galvanic protection provided by the first layer 11, on the one hand through its ability to clog the pores of the first layer 11 and on the other hand by its porosity, which makes it possible to regulate the speed of the electrochemical reactions near the first layer 11.

The paint is a one-component paint in aqueous phase. The paint comprises at least one of also five synthetic resin made from polymers or copolymers such as acrylic, styrene acrylic, vinyl chloride, polyvinyl chloride acrylate, vinylidene chloride, vinyl, methacrylate, polyvinyl acetate polymers or copolymers.

The second layer 13 and the paint advantageously have no organic solvent or co-solvent, in particular derived from hydrocarbons, and without bisphenol.

The paint is for example formulated from compounds belonging to the positive lists of the European Union for contact with foodstuffs (European regulation no. 10/2011) having regulatory approvals as of the filing date of this patent (for example, a Certificate of French Sanitary Compliance (ACS), or an English WRAS certificate) for products placed in contact with water intended for human consumption.

The second layer 13 advantageously includes one or more active ingredients able to come into contact with water intended for human consumption, for example bactericidal and/or passivating agents (for example silver, copper, copper oxide, zinc phosphate, zinc oxide). The bactericidal agent is for example a copper salt able to restrict the activity of the bacteria in soil 3. The bactericidal active ingredients advantageously have a very slow migration (water, soil) once the emulsion has coalesced. The solid particles of the bactericidal agents are then encapsulated by the resin: the diffusion of the water from the outside environment through the resin leads to the ionization of those agents, which will subsequently be released into the outside environment by slow diffusion.

We will now describe a method for depositing the outer coating 9 on the piping element 7. The method includes a step a) for depositing the first layer 11 on the piping element 7 as described above, and a step b) for depositing a second layer 13 on the first layer 11 as described above.

In step a), the first layer 11 is advantageously deposited by thermal spraying, preferably by electric arc.

A sufficient quantity of material is deposited to obtain a surface density of the first layer 11 of at least 200 g/m², preferably at least 350 g/m². The spraying is for example done from solid wires or cored wires, depending on the availability of the alloyed zinc.

In step b), the second layer 13 is advantageously deposited on the first layer 11, while the latter is not covered with white fluorescence, i.e., with a reduced time lag between the deposition of the second layer 13 and the first layer 11.

In step b), the second layer 13 is advantageously deposited by gun without compressed air, in particular for large surfaces, and/or by brush, in particular for small surfaces or touchups, such that the second layer 13 has a dry thickness advantageously comprised between 60 μm and 150 μm, for example a dry thickness of approximately 120 μm. The second layer 13 advantageously has a dry surface density comprised between 120 g/m² and 350 g/m², for example a dry surface density of 250 g/m².

The deposition of the second layer 13 is advantageously at least partially done by gun without compressed air, the application done by gun being done over a surface having a temperature comprised between 35° C. and 60° C. That surface is brought to said temperature for example by immersing at least part of the piping element 7 coated with the first layer 11 in a tub of water at that temperature.

The water advantageously contains a surface conversion agent, for example zinc phosphate, zinc oxide, to cover the first layer 11 with a superficially transformed alloy film. The surface conversion agent suitable for zinc alloy advantageously has regulatory approvals contact with water intended for human consumption.

The wetting of the first layer 11 by water containing the active ingredient leads to covering the surface of the first layer 11 with an alloy film superficially transformed, for example, into zinc hydroxide and oxide, or zinc phosphate, able to delay the subsequent oxidation of the first layer 11 once the piping element 1 is subjected to its usage environment, and which are favorable to increasing the length of the protection.

### EXAMPLE OF COATING ACCORDING TO THE INVENTION

Outer coating 9 on piping 7 made from ductile cast iron, made up of a first metallized layer 11 deposited by electric arc, with 400 g/m² of zinc-aluminum alloy at 15% aluminum, and a second layer 13 made up of a one-component paint in aqueous phase, the second layer 13 having a dry thickness of 120 μm and a dry surface density of 250 g/m².

The paint is an emulsion made from acrylic-PVDC copolymer and has been applied after immersing the piping 7 coated with the first layer 11 in a tub of water at 60° C. containing a zinc polyphosphate to create a surface film of several microns on the surface of the first layer 11.

The copolymer emulsion made from acrylic-PVDC copolymer comprises an active ingredient, for example a copper salt, in order to restrict the activity of the bacteria in the soil 3 at the outer coating 9.

Owing to the features of the first layer 11 and the second layer 13 described above, the outer coating 9 provides even more effective corrosion protection for the piping element 7, in particular in corrosive soil 3, with improved sanitary environmental properties. In fact, the second layer 13 very effectively plugs the pores of the first layer 11. The combination of the second layer 13 on the first layer 11 is the beginning of conversion of the metal droplet surface making up the first layer 11. Furthermore, the outer coating 9, due to its composition and application method, has a very competitive cost.

The optional feature according to which the surface of the first layer 11 is brought to the temperature between 35° C. and 60° C. by immersing at least part of the piping element 7 coated with the first layer 11 in water preferably containing a surface conversion agent, favors the appearance of a superficially transformed alloy film.

Furthermore, the optional feature according to which the second layer 13 has no organic solvent or co-solvent, in particular solvent or co-solvent derived from hydrocarbons, has the advantage that the outer coating 9 is compatible with the current regulatory requirements for contact with water intended for human consumption.

Additionally, the absence of bisphenol in the formulation of the selected resins eliminates the potential risk of toxicity for humans associated with that molecule.

This facilitates the coating operations for the piping element 7. It is in fact possible to deposit the same coating 9 on zones intended to be in contact only with the corrosive soil 3 and over zones, such as a pipe end or a cutting zone, that may be in contact with water 5 intended for human consumption.

Furthermore, the environmental impact is greatly reduced by the elimination of volatile organic solvents, or “VOCs”. The safety conditions for the operators manufacturing or placing the piping element 1 are improved. The treatment and elimination of waste related to the piping element 1 can be done using conventional paint recycling installations.

Owing to this optional feature according to which the second layer 13 includes one or more active ingredients that may have a bactericidal and/or passivating action, the long-term strength of the coating 9 is improved in all soils.

1. An outer coating for an underground piping element made from iron, the outer coating having a first porous layer and a second porous layer positioned on the first layer and able to plug the pores of the first layer wherein:
the first layer includes a substantially pure zinc or a zinc alloy or pseudo-alloy, the alloy or pseudo-alloy including, in terms of mass, at least 50% zinc, and
the second layer comprises a one-component paint in the aqueous phase made from at least one synthetic resin emulsified, dispersed or dissolved in water.

2. The outer coating according to claim 1, wherein said at least one synthetic resin is formulated from at least one polymer or at least one copolymer chosen from the list consisting of acrylic, styrene acrylic, vinyl halide such as vinyl chloride, polyvinyl chloride acrylate, vinylidene halide such as vinylidene chloride, vinyl, methacrylate, polyvinyl acetate polymers or copolymers, and mixtures thereof.

3. The outer coating according to claim 1, wherein the first layer includes magnesium and/or copper and/or silver, at respective mass concentrations of between 0% and 5%.

4. The outer coating according to claim 1, wherein the first layer has a surface density of at least 200 g/m².

5. The outer coating according to claim 1, wherein the second layer has no organic solvent or co-solvent and without bisphenol.

6. The outer coating according to claim 1, wherein the second layer includes one or more active ingredients able to come into contact with water intended for human consumption and have a bactericidal and/or passivating action.

7. The outer coating according to claim 1, wherein the second layer has a dry surface density comprised between 120 g/m² and 350 g/m².

8. A coated piping element, made from iron, designed to be placed underground, including an outer coating according to claim 1.

9. A method for depositing an outer coating on a piping element made from iron, designed to be placed underground, wherein the method includes the following steps:
a) deposition by metallization, on the piping element of a first porous layer including substantially pure zinc or a zinc alloy or pseudo-alloy, the alloy or pseudo-alloy including, in terms of mass, at least 50% zinc, and
b) deposition on the first layer, not covered with white efflorescence, of a second porous layer including a one-component paint in aqueous phase, made from at least one synthetic resin emulsified, dispersed or dissolved in the water.

10. The method according to claim 9, wherein, in step b), said at least one synthetic resin is formulated from at least one polymer or at least one copolymer chosen from the list consisting of acrylic, styrene acrylic, vinyl halide such as vinyl chloride, polyvinyl chloride acrylate, vinylidene halide such as vinylidene chloride, vinyl, methacrylate, polyvinyl acetate polymers or copolymers, and mixtures thereof.

11. The method according to claim 9, wherein step b) for depositing the second layer is done by gun, and/or with a brush or roller, such that the second layer has a dry thickness comprised between 60 μm and 150 μm.

12. The method according to claim 9, wherein step b) for depositing the second layer is done such that the second layer has a dry surface density comprised between 120 g/m² and 350 g/m².

13. The method according to claim 9, wherein step b) for depositing the second layer is at least partially done by gun with no compressed air, the application by gun being done on a surface having a temperature comprised between 35° C. and 60° C.

14. The method according to claim 13, wherein, in step b), said surface is brought to the temperature comprised between 35° C. and 60° C. by immersing at least part of the piping element in water to cover the first layer with a superficially transformed alloy film, the conversion agent being suitable for contact with water intended for human consumption.

15. The outer coating according to claim 1, wherein the underground piping element is made from cast iron.

16. The outer coating according to claim 1, wherein the alloy or pseudo-alloy includes, in terms of mass, between 0.5% and 40% aluminum.

17. The outer coating according to claim 3, wherein the first layer includes magnesium and/or copper and/or silver, at respective mass concentrations of between 0.5% and 3%.

18. The outer coating according to claim 3, wherein the second layer has no solvent or co-solvent derived from hydrocarbons.

19. The coated piping element according to claim 8, made from cast iron.

20. The method according to claim 9, wherein the piping element is made from cast iron.

21. The method according to claim 9, wherein, in step a), deposition by metallization is made by electric arc.

22. The method according to claim 9, wherein the alloy or pseudo-alloy includes, in terms of mass, between 0.5% and 3% aluminum.

23. The method according to claim 20, wherein said water contains a surface conversion agent.
